(19) United States
(12) Patent Application Publication
(10) Pub. No.: US 2026/0254290 A1
(43) Pub. Date: Aug. 27, 2026

(54) MOTOR AND ROBOT INCLUDING MOTOR

(71) Applicant: SUMITOMO HEAVY INDUSTRIES, LTD., Tokyo (JP)

(72) Inventor: Koji MORITANI, Yokosuka-shi (JP)

(21) Appl. No.: 19/365,258

(22) Filed: Oct. 22, 2025

(30) Foreign Application Priority Data
Oct. 30, 2024 (JP) 2024-191178

(51) Int. Cl. H02K 1/14; H02K 1/278

(52) U.S. Cl. CPC H02K 1/146; H02K 1/278; H02K 2213/03

(57) ABSTRACT

A motor includes: a stator including an iron core having a plurality of teeth and a plurality of slots extending in a radial direction, and a winding wire wound around each of the slots; and a rotor including a magnet having magnetic poles facing the plurality of teeth in the radial direction, in which the iron core is integrally formed in a circumferential direction, the magnet is formed of a material having a residual magnetic flux density of 1.4 T or more, and an iron core utilization rate of the iron core is less than 60%.

### CROSS-REFERENCE TO RELATED APPLICATIONS

This application claims priority to Japanese Patent Application No. 2024-191178, filed on Oct. 30, 2024, which is incorporated by reference herein in its entirety.

### BACKGROUND

### Technical Field

Certain embodiments of the present invention relate to a motor and a robot including the motor.

### Description of Related Art

A motor including a rotor and a stator is known. For example, the related art describes an electric motor including a rotor having a permanent magnet and a stator having teeth disposed to face the rotor. The rotor of the electric motor includes an iron core and a permanent magnet disposed in an insertion hole of the iron core, and a residual magnetic flux density of the permanent magnet is 1.3 T or more.

### SUMMARY

According to an embodiment of the present invention, there is provided a motor including: a stator including an iron core having a plurality of teeth and a plurality of slots extending in a radial direction, and a winding wire wound around each of the slots; and a rotor including a magnet having magnetic poles facing the plurality of teeth in the radial direction. The iron core is integrally formed in a circumferential direction, the magnet is formed of a material having a residual magnetic flux density of 1.4 T or more, and an iron core utilization rate of the iron core is less than 60%.

According to another embodiment of the invention, there is provided a robot. The robot includes the motor.

Note that, any combination of the above components, and those obtained by substituting the components or expressions in the present invention with each other between methods, systems, or the like are also effective as aspects of the present invention.

### BRIEF DESCRIPTION OF THE DRAWINGS

FIG. 1 is a cross-sectional view obtained by cutting a motor of one embodiment taken along a plane perpendicular to an axial direction.

FIG. 2 is a side view showing a robot according to another embodiment.

### DETAILED DESCRIPTION

The inventor has obtained the following recognition. There is a need for a motor that is small-sized, satisfies desired performance, and can be cost-reduced. To improve the torque performance, it is conceivable to perform high-density winding by manual winding. However, this method is high in cost because the method cannot be automated. In addition, to realize the high-density winding, it is conceivable to adopt a split core in which an iron core is split into a plurality of pieces for each tooth. However, in this method, post-processes such as connection work after winding are increased, and dedicated equipment is used. Therefore, this method results in high costs. In addition, in a multi-pole multi-slot specification, a core back, which is a connecting portion of the split core, is narrowed. As a result, assembling performance degrades. In addition, to accurately assemble the iron core, a cutting process of the core after connection is added, which results in high costs.

In a motor configuration of the related art, there is an issue in that when the density of a winding wire is reduced to reduce costs, the performance degrades. From these, in the motor of the related art, it is insufficient from the viewpoint of providing a motor advantageous for cost reduction while suppressing performance degradation.

The present invention has been made in view of such an issue, and it is desirable to provide a motor advantageous for cost reduction while suppressing performance degradation.

Hereinafter, the present invention will be described with reference to each drawing based on preferred embodiments. In the embodiments and modification examples, the same or equivalent components and members will be represented by the same reference numerals and duplicate descriptions will be appropriately omitted. In addition, the dimensions of members in each drawing have been appropriately enlarged and reduced for easy understanding. In addition, in each drawing, some of the members not important for the description of the embodiments are not shown. In addition, when the same or equivalent components are described to be distinguished from each other, the description will be made with capital letters such as A, B, and C added to the ends of the reference numerals.

In addition, although terms including ordinal numbers such as “first” and “second” will be used to describe various components, the terms will be used only for the purpose of distinguishing one component from the other component and no component is limited by the terms.

### One Embodiment

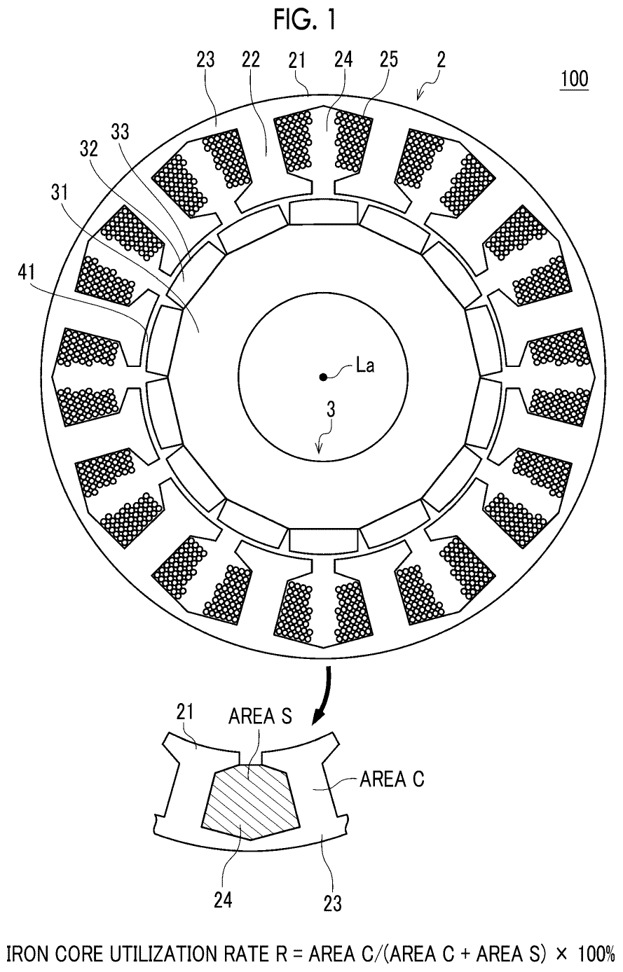

A motor 100 according to one embodiment of the present invention will be described with reference to FIG. 1. FIG. 1 is a cross-sectional view of the motor 100. This figure is a cross-sectional view cut taken along a plane perpendicular to a rotation axis La of a rotor 3 of the motor 100.

Hereinafter, a direction parallel to the rotation axis La is referred to as an “axial direction”, and a circumferential direction and a radial direction of a circle centered on the rotation axis La are referred to as a “circumferential direction” and a “radial direction”, respectively.

The motor 100 includes the rotor 3 and the stator 2. The motor 100 may be any motor having the rotor 3 and the stator 2, and in this example, the motor 100 is a radial gap type inner rotor motor. The motor 100 may be an outer rotor motor. As an example, the motor 100 is preferably used for driving a joint of a robot.

The stator 2 includes an annular core back 23 surrounding the rotation axis La, a plurality of teeth 22 extending in the radial direction from the core back 23, and an iron core 21 having a plurality of slots 24 formed between two adjacent teeth 22.

The plurality of teeth 22 are disposed at predetermined intervals in the circumferential direction. The number of teeth 22 may be a multiple of 3, but is preferably 9 or more from the viewpoint of ensuring performance, and is 12 in this example. The number of teeth 22 is preferably 18 or fewer from the viewpoint of ensuring productivity.

The iron core 21 is a non-split core integrally formed in the circumferential direction. The iron core 21 is formed by laminating a predetermined number of electromagnetic steel sheets such as silicon steel sheets, which are punched out by a press, in the axial direction and performing insulation treatment or the like.

The stator 2 includes a winding wire 25 wound around a slot 24. In this example, the winding wire 25 is formed by so-called nozzle winding in which an electric wire is supplied from the tip of a nozzle that rotates around a tooth 22 and is wound around the tooth 22. As an example, the winding wire 25 is three-phase star-connected.

The rotor 3 includes a hollow cylindrical rotor cylinder portion 31 surrounding the rotation axis La, and a magnet 32 secured to an outer periphery of the rotor cylinder portion 31. The rotor 3 is supported to be rotatable around the rotation axis La by bearing means (not shown). A plurality of magnetic poles 33 are provided on the outer peripheral surface of the magnet 32, which faces the stator 2, by magnetization. Although there is a known combination of the number of teeth and the number of magnetic poles, the number of magnetic poles 33 in this example is 14. This combination has relatively small cogging. Since the rotor 3 of this example is a surface magnet type, the magnetic flux from the magnet 32 can be directly guided to the teeth 22, which is advantageous in achieving high performance.

The magnet 32 of this example is 14 segment magnets split for each magnetic pole. In this case, a relatively high magnetic force is easily obtained. The magnet 32 may be an annular magnet integrally formed in the circumferential direction. In this case, assembling is relatively easy. The rotor cylinder portion 31 is formed of a magnetic material and functions as a back yoke of the magnet 32. The magnet 32 is surrounded by the iron core 21 with a radial gap 41 interposed therebetween. The radial gap 41 is also referred to as a radial gap.

An iron core utilization rate of the iron core 21 will be described. Hereinafter, unless otherwise specified, the “area” refers to a cross-sectional area when viewed from the axial direction. In the motor of the related art, the circumferential width of a tooth and the radial width of the core back 23 are increased, and the iron core utilization rate is set to 70% or more. However, in the motor 100 of the embodiment, the iron core utilization rate is set to less than 60% (hereinafter, referred to as an “iron core utilization rate condition”). In this case, the area of the slot 24 is relatively expanded, and the aligned winding of the winding wire 25 is easily realized. The iron core utilization rate can be calculated by Equation 1.

$$Iron core utilization rate R = Area C / ( Area C + Area S ) \times 100 \% \qquad ( Equation 1 )$$

The area C is the total area of the iron core 21, and the area S is the total area of the slot 24.

The residual magnetic flux density of the magnet 32 will be described. Hereinafter, unless otherwise specified, the “residual magnetic flux density” refers to the residual magnetic flux density of a material that constitutes the magnet 32. In the motor of the related art, a magnet having a residual magnetic flux density of 1.3 T or less is used. However, in the motor 100 of the embodiment, the residual magnetic flux density of the magnet 32 is 1.4 T or more (hereinafter, referred to as a “residual magnetic flux density condition”). In this case, the magnetic flux linkage of the winding wire 25 increases. Therefore, even when the residual magnetic flux density condition is combined with the iron core utilization rate condition, it is easy to ensure the torque performance.

The packing factor of the winding wire 25 will be described. Hereinafter, unless otherwise specified, the “packing factor” refers to the ratio of the effective cross-sectional area of a winding wire to the area of a slot. In the motor of the related art, the packing factor is set to 40% or more to ensure performance. This can be easily realized by a split core. However, in the non-split core that is integral in the circumferential direction, the only option is to use low-productivity manual winding or the like, which has been an obstacle to cost reduction. In the motor 100 of the embodiment, the packing factor of the winding wire 25 is set to less than 40% (hereinafter, referred to as a “packing factor condition”). More preferably, the packing factor condition may be set to 30% or less. In this case, even an integral core that is not split in the circumferential direction can form the winding wire 25 by using the nozzle winding described above or flyer winding. Therefore, it is easy to achieve cost reduction by automation. Even when the packing factor condition is combined with the iron core utilization rate condition and the residual magnetic flux density condition, the performance can be ensured, which is also advantageous for achieving cost reduction.

The radial gap 41 between the magnet 32 and the teeth 22 will be described. Hereinafter, unless otherwise specified, the “radial gap” refers to a difference in radius between the magnet and the teeth. In the motor of the related art, the radial gap is set to 2% or more of the outer diameter of the stator. In this case, the magnetic resistance of the radial gap is large, and the performance of the magnet cannot be sufficiently exhibited.

In the motor 100 of the embodiment, the radial gap 41 between the magnet 32 and the teeth 22 is set to a value larger than 0.4% and smaller than 1% of the outer diameter of the stator 2 (hereinafter, referred to as a “radial gap condition”). For example, in a case where the outer diameter of the stator 2 is 50 mm, the radial gap 41 can be set to a value larger than 0.2 mm and smaller than 0.5 mm, which is a value larger than 0.4% and smaller than 1% of 50 mm. In this case, the magnetic resistance of the radial gap is reduced, the permeance coefficient is increased, and the performance of the magnet can be easily exhibited. By combining the radial gap condition with the iron core utilization rate condition, the residual magnetic flux density condition, and the packing factor condition, it is possible to easily ensure desired performance while achieving cost reduction.

The surface magnetic flux density of a magnetic pole will be described. In the motor of the related art, the maximum value of the surface magnetic flux density of the magnetic pole is set to 0.9 T or less in a state where the magnet faces the teeth. However, in the motor 100 of the embodiment, the maximum value of the surface magnetic flux density of the magnetic pole 33 is 1.1 T or more in a state where the magnet 32 faces the teeth 22 (hereinafter, referred to as a “surface magnetic flux density condition”). In this case, since the magnetic flux linkage of the winding wire 25 increases, the torque performance is easily ensured even when combined with each of the above-described configuration conditions. The surface magnetic flux density condition can be realized by adjusting the permeance coefficient of a magnetic circuit of the magnet 32.

The operation of the motor 100 of the embodiment will be described. In the motor 100, the rotor 3 is rotated by the torque generated based on a drive principle of a known brushless motor. In the motor 100, when a 3-phase drive current is supplied to the winding wire 25 from a drive circuit (not shown), a rotating magnetic field is generated on the inner periphery of the iron core 21. The torque is generated in the rotor 3 with respect to the stator 2 by the interaction between the rotating magnetic field and the magnetic field of the magnetic poles 33 of the magnet 32, and the rotor 3 is rotated by the torque.

The features of the motor 100 of one embodiment will be described. The motor 100 includes the stator 2 including the iron core 21 having the plurality of teeth 22 and the plurality of slots 24 extending in the radial direction, and the winding wire 25 wound around the slot 24, and the rotor 3 including the magnet 32 having the magnetic poles 33 facing the plurality of teeth 22 in the radial direction. The iron core 21 is integrally formed in the circumferential direction, and the magnet 32 is formed of a material having a residual magnetic flux density of 1.4 T or more, and the iron core utilization rate of the iron core 21 is less than 60%.

According to this configuration, compared to the split core, a process of connecting cores to each other after winding is not required, and post-processes such as the connection of the winding wire 25 are facilitated, which are advantageous for cost reduction. In addition, since the iron core 21 has a relatively high strength by being integrated, even when the width of the core back or the teeth is reduced to set the iron core utilization rate to less than 60%, the iron core is less likely to be deformed, and high accuracy is easily ensured. By reducing the iron core utilization rate, the slot is widened, the winding wire is aligned to make winding easier, and the number of substantial winding wires can be increased. By combining the magnet 32 having the residual magnetic flux density of 1.4 T or more with such a stator, the performance degradation can be minimized. As a result, it is possible to provide a motor advantageous for cost reduction while suppressing the performance degradation. The iron core utilization rate is preferably 40% or more.

As an example, in the motor 100, the packing factor of the winding wire 25 in the slot 24 is 30% or less. In this case, compared to a case where the packing factor is high, the amount of winding wires is reduced and the productivity is improved, which are advantageous for cost reduction. Even when the packing factor is low, the performance degradation can be minimized by combining the magnets 32 having the residual magnetic flux density of 1.4 T or more. In addition, since the clearance in the slot is increased, the productivity is improved because the nozzle for winding can easily pass through, and the winding wire is further aligned. The winding wire is aligned, so that the winding resistance is reduced, which is advantageous for improving the performance. The packing factor is preferably 20% or more.

As an example, in the motor 100, the radial gap 41 between the magnet 32 and the teeth 22 is less than 1% of the outer diameter of the stator 2. In this case, the magnetic resistance when viewed from the magnet 32 is reduced, and the magnetic flux density of the radial gap 41 is increased to a level close to the residual magnetic flux density, which is more advantageous for improving the performance than in a case where the radial gap 41 is large. As a result, even in a case where the iron core utilization rate is less than 60% and the packing factor is 30% or less, the performance degradation can be minimized. The radial gap 41 is preferably 0.1 mm or more. The outer diameter of the stator 2 is the diameter of a cylinder that circumscribes the stator 2.

As an example, in the motor 100, the maximum value of the surface magnetic flux density of the magnetic pole 33 is 1.1 T or more in a state where the magnet 32 faces the teeth 22. This is advantageous for improving the performance than in a case where the surface magnetic flux density is low. In particular, even when the iron core utilization rate is less than 60% and the packing factor is 30% or less, the performance degradation can be minimized.

As an example, the motor 100 has an inner rotor structure in which the rotor 3 is surrounded by the stator 2, and has a frameless structure in which an outer peripheral surface of the iron core 21 is an outer peripheral surface of the motor 100. In this case, since no frame is provided, the motor 100 can be easily incorporated into mounting equipment such as a robot on which the motor 100 is mounted.

As an example, in the motor 100, the number of teeth 22 is 12, the number of magnetic poles 33 is 14, and the magnet 32 has a segment structure split for each magnetic pole. In this case, since the number of teeth is relatively small, winding can be performed at a high density, and the productivity can be improved compared to a case where the number of teeth is large.

The above is the description of one embodiment.

### Another Embodiment

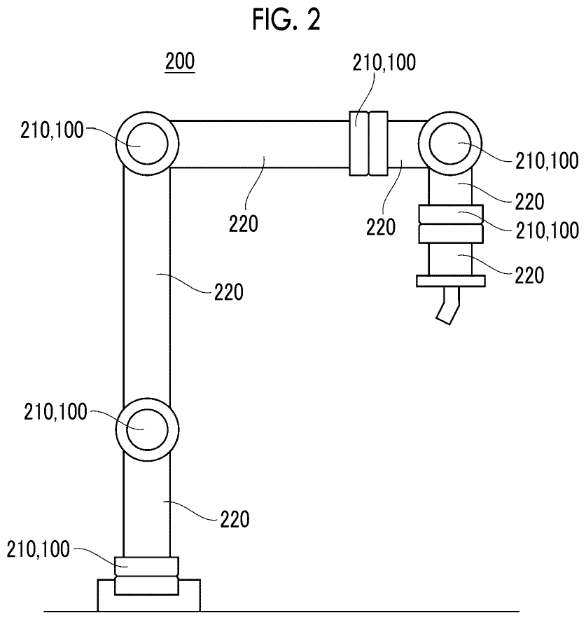

A configuration of a robot 200 according to another embodiment will be described with reference to FIG. 2. FIG. 2 is a side view schematically showing the robot 200 according to the present embodiment. The robot 200 is an articulated robot having a plurality of arms connected between a tip end side and a base end side via a plurality of joints. The robot 200 of the present embodiment has six joints 210 and six arms 220. The motor 100 of one embodiment is incorporated into each joint 210. As the rotor 3 of the motor 100 rotates, an arm 220 rotates around a joint 210, and the robot 200 executes a predetermined operation.

The present invention has been described above based on the embodiments. These are examples, and it will be understood by those skilled in the art that various modifications and changes can be made within the scope of the claims of the present invention, and such modification examples s and changes are also within the scope of the claims of the present invention. Therefore, the descriptions and the drawings in the present specification should be treated as illustrative, not limiting.

Hereinafter, other modification examples will be described. In the descriptions and the drawings, the same or equivalent components and members as those in one embodiment are denoted by the same reference numerals. Descriptions overlapping with the above descriptions will be appropriately omitted, and configurations different from the above descriptions will be described with emphasis.

In the descriptions of the embodiments, an example in which the rotor 3 is a surface magnet type has been shown. However, the present invention is not limited thereto. The rotor may be a buried magnet type.

In the descriptions of the embodiments, an example in which the winding wire 25 is formed by the nozzle winding has been shown. However, the present invention is not limited thereto. For example, a winding wire may be formed by a so-called flyer winding.

In the descriptions of the embodiments, an example in which the winding wire 25 is wound in alignment has been shown in FIG. 1. However, the present invention is not limited thereto. For example, a winding wire may be wound by so-called “bale winding”. The bale winding is a disposition in which a winding wire on an upper layer is housed in a recessed portion formed between the winding wire on the upper layer and a winding wire on a lower layer.

In the descriptions of the embodiments, an example in which the rotor 3 is hollow has been shown. However, the present invention is not limited thereto.

For example, the rotor may include a shaft at a rotation center.

Each of these modification examples has the same functions and effects as those of one embodiment.

Any combination of the above-described respective embodiments and modification examples are also useful as embodiments of the present invention. The new embodiments generated by the combinations have the combined effects of the embodiments and the modification examples combined with each other.

It should be understood that the invention is not limited to the above-described embodiment, but may be modified into various forms on the basis of the spirit of the invention. Additionally, the modifications are included in the scope of the invention.

What is claimed is:

1. A motor comprising:
a stator including an iron core having a plurality of teeth and a plurality of slots extending in a radial direction, and a winding wire wound around each of the slots; and
a rotor including a magnet having magnetic poles facing the plurality of teeth in the radial direction,
wherein the iron core is integrally formed in a circumferential direction,
the magnet is formed of a material having a residual magnetic flux density of 1.4 T or more, and
an iron core utilization rate of the iron core is less than 60%.

2. The motor according to claim 1,
wherein the rotor includes a rotor cylinder portion having a hollow cylindrical shape that surrounds a rotation axis, and the magnet is secured to an outer periphery of the rotor cylinder portion.

3. The motor according to claim 2,
wherein the iron core is a non-split core integrally formed in the circumferential direction.

4. The motor according to claim 3, wherein the iron core utilization rate of the iron core is 40% or more.

5. The motor according to claim 1,
wherein the stator includes a core back having an annular shape that surrounds a rotation axis, the plurality of teeth extends from the core back in the radial direction, and the plurality of slots are each formed between two adjacent teeth.

6. The motor according to claim 1, wherein a packing factor of the winding wire in each of the slots is 30% or less.

7. The motor according to claim 6,
wherein a radial gap between the magnet and the teeth is less than 1% of an outer diameter of the stator.

8. The motor according to claim 7,
wherein a maximum value of a surface magnetic flux density of each of the magnetic poles in a state where the magnet faces the teeth is 1.1 T or more.

9. The motor according to claim 8,
wherein the motor has an inner rotor structure in which the rotor is surrounded by the stator, and
has a frameless structure in which an outer peripheral surface of the iron core is an outer peripheral surface of the motor.

10. The motor according to claim 9,
wherein the number of the teeth is 12,
the number of the magnetic poles is 14, and
the magnet has a segment structure split for each magnetic pole.

11. A robot comprising:
the motor according to claim 1.
